(19) United States
(12) Patent Application Publication
(10) Pub. No.: US 2014/0022370 A1
(43) Pub. Date: Jan. 23, 2014

(54) EMOTION RECOGNITION APPARATUS USING FACIAL EXPRESSION AND EMOTION RECOGNITION METHOD USING THE SAME

(71) Applicant: The Industry & Academic Cooperation In Chungnam National University(IAC), (US)

(72) Inventors: Jin Hun SOHN, Daejeon (KR); Eung-Hee KIM, Seoul (KR); Sangsup CHOI, Seoul (KR); Kyungmin LEE, Gyeonggi-do (KR)

(73) Assignee: THE INDUSTRY & ACADEMIC COOPERATION IN CHUNGNAM NATIONAL UNIVERSITY(IAC), Daejeon (KR)

(21) Appl. No.: 13/711,781

(22) Filed: Dec. 12, 2012

(30) Foreign Application Priority Data
Jul. 23, 2012 (KR) 10-2012-0080060

(51) Int. Cl. G06K 9/00

(52) U.S. Cl. CPC G06K 9/00315
USPC 348/78; 348/77; 382/103

(57) ABSTRACT

The present invention relates to an emotion recognition apparatus using facial expressions including: a camera adapted to acquire a first video of an object corresponding to each of a plurality of emotions classified by a previously set reference; a user input unit adapted to receive a plurality of first frames in the first video designated by a user; a control unit adapted to recognize the face of the object contained in the plurality of first frames, extracting the facial elements of the object by using the recognized face, and extracting the variation patterns of the plurality of emotions by using the facial elements; and a memory adapted to store the extracted variation patterns of the plurality of emotions.

Pursuant to 35 U.S.C. §119(a), this application claims the benefit of earlier filing date and right of priority to Korean Application No. 10-2012-0080060, filed on Jul. 23, 2012, the contents of which are hereby incorporated by reference herein in their entirety.

### BACKGROUND OF THE INVENTION

1. Field of the Invention

The present invention relates to an emotion recognition apparatus using facial expressions and an emotion recognition method using the same, and more particularly, to an emotion recognition apparatus using facial expressions and an emotion recognition method using the same wherein the variations of the facial expressions of an object are sensed to objectively recognize a plurality of emotions from the sensed facial expressions of the object.

2. Background of the Related Art

Multimodal emotion recognition means the recognition of the emotion using various kinds of information such as facial expressions, speech, gestures, gaze, head movements, contexts and the like, and if multimodal information is inputted through multimodal interface, the input information is converged and analyzed at modalities.

Further, various learning algorithms are used to extract and classify the features of the inputted information in the multi-modalities. At this time, error rates in the analyzing and recognizing the results may be varied in accordance with the kinds of learning algorithms.

A function of recognizing the emotions of an object is a main part of an intelligent interface, and to do this, emotion recognition technologies using the facial expressions, voices and other features of the object have been developed.

Most of the emotion recognition technologies using the user's facial expressions are carried out by using still videos and various algorisms, but the recognition rate does not reach the degree to be satisfied.

Further, the reaction of the object is not measured through the object's natural, emotions, and the data of the reaction of the object in the state of an artificial emotion is used, so that it often does not match real events. Accordingly, there is a definite need for the development of advanced emotion recognition technologies.

### SUMMARY OF THE INVENTION

Accordingly, the present invention has been made in view of the above-mentioned problems occurring in the prior art, and it is an object of the present invention to provide an emotion recognition apparatus using facial expressions and an emotion recognition method using the same wherein the variations of the facial expressions of an object are measured to objectively recognize six kinds of emotions (for example, joy, surprise, sadness, anger, fear and disgust) from the sensed facial expressions of the object.

To accomplish the above object, according to a first aspect of the present invention, there is provided an emotion recognition apparatus using facial expressions including: a camera adapted to acquire a first video of an object corresponding to each of a plurality of emotions classified by a previously set reference; a user input unit adapted to receive a plurality of first frames in the first video designated by a user; a control unit adapted to recognize the face of the object contained in the plurality of first frames, extracting the facial elements of the object by using the recognized face, and extracting the variation patterns of the plurality of emotions by using the facial elements; and a memory adapted to store the extracted variation patterns of the plurality of emotions, wherein if a second video of the object is acquired through the camera, a first variation pattern of the facial elements of the object contained in the second video is extracted, and the emotion corresponding to the variation pattern that is the same as the first variation pattern from the plurality of variations patterns stored in the memory is determined as the emotion of the object by means of the control unit.

To accomplish the above object, according to a second aspect of the present invention, there is provided an emotion recognition apparatus using facial expressions including: a camera adapted to acquire a first video of an object corresponding to each of a plurality of emotions classified by a previously set reference; a user input unit adapted to receive a plurality of first frames in the first video designated by a user; a control unit adapted to recognize the face of the object contained in the plurality of first frames, extracting the facial elements of the object by using the recognized face, and extracting the variation patterns of the plurality of emotions by using the facial elements; and a memory adapted to store the extracted variation patterns of the plurality of emotions, wherein if a second video of the object is acquired through the camera, a first variation pattern of the facial elements of the object contained in the second video is extracted, and the emotion corresponding to the variation pattern that is most similar to the first variation pattern from the plurality of variations patterns stored in the memory is determined as the emotion of the object by means of the control unit.

To accomplish the above object, according to a third aspect of the present invention, there is provided an emotion recognition method using facial expressions including the steps of acquiring a first video of an object corresponding to each of a plurality of emotions classified by a previously set reference; receiving a plurality of first frames designated in the first video; recognizing the face of the object contained in the plurality of first frames; extracting the facial elements of the object by using the recognized face; extracting the variation patterns of the plurality of emotions by using the facial elements; storing the extracted variation patterns of the plurality of emotions; acquiring a second video of the object; extracting a first variation pattern of the facial elements of the object contained in the second video; and determining the emotion corresponding to the variation pattern that is the same as the first variation pattern from the plurality of stored variations patterns as the emotion of the object.

To accomplish the above object, according to a fourth aspect of the present invention, there is provided an emotion recognition method using facial expressions including the steps of: acquiring a first video of an object corresponding to each of a plurality of emotions classified by a previously set reference; receiving a plurality of first frames designated in the first video; recognizing the face of the object contained in the plurality of first frames; extracting the facial elements of the object by using the recognized face; extracting the variation patterns of the plurality of emotions by using the facial elements; storing the extracted variation patterns of the plurality of emotions; acquiring a second video of the object; extracting a first variation pattern of the facial elements of the object contained in the second video; and determining the emotion corresponding to the variation pattern that is most similar to the first variation pattern from the plurality of stored variations patterns as the emotion of the object.

To accomplish the above object, according to a fifth aspect of the present invention, there is provided an emotion recognition method using facial expressions in a recording medium where programs of commands executed by a digital processing device are typologically set in such a manner as to be readable by means of the digital processing device, the method including the steps of: acquiring a first video of an object corresponding to each of a plurality of emotions classified by a previously set reference; receiving a plurality of first frames designated in the first video; recognizing the face of the object contained in the plurality of first frames; extracting the facial elements of the object by using the recognized face; extracting the variation patterns of the plurality of emotions by using the facial elements; storing the extracted variation patterns of the plurality of emotions; acquiring a second video of the object; extracting a first variation pattern of the facial elements of the object contained in the second video; and determining the emotion corresponding to the variation pattern that is the same as the first variation pattern from the plurality of stored variations patterns as the emotion of the object.

To accomplish the above object, according to a sixth aspect of the present invention, there is provided an emotion recognition method using facial expressions in a recording medium where programs of commands executed by a digital processing device are typologically set in such a manner as to be readable by means of the digital processing device, the method including the steps of: acquiring a first video of an object corresponding to each of a plurality of emotions classified by a previously set reference; receiving a plurality of first frames designated in the first video; recognizing the face of the object contained in the plurality of first frames; extracting the facial elements of the object by using the recognized face; extracting the variation patterns of the plurality of emotions by using the facial elements; storing the extracted variation patterns of the plurality of emotions; acquiring a second video of the object; extracting a first variation pattern of the facial elements of the object contained in the second video; and determining the emotion corresponding to the variation pattern that is most similar to the first variation pattern from the plurality of stored variations patterns as the emotion of the object.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a block diagram showing a configuration of an emotion recognition apparatus using facial expressions according to the present invention;

FIG. 2 is a block diagram showing face recognition means, facial element extraction means, and emotion recognition means in the emotion recognition apparatus using facial expressions according to the present invention;

FIG. 3 is a flow chart showing an emotion recognition method using facial expressions according to the present invention;

FIGS. 4a to 4d are exemplary views showing the emotion recognition method using facial expressions according to the present invention;

FIG. 5 is a flow chart showing another emotion recognition method using facial expressions according to the present invention; and

FIGS. 6a and 6b are exemplary views showing still another emotion recognition method using facial expressions according to the present invention.

### DETAILED DESCRIPTION OF THE PREFERRED EMBODIMENT

Hereinafter, an explanation on an emotion recognition apparatus using facial expressions and an emotion recognition method using the same according to the preferred embodiments of the present invention will be in detail given with reference to the attached drawings.

The terms such as modules, units and the like are used to explain a variety of components, for easy description, but the components are not defined as the terms. That is, the terms are used just to distinguish one component from other components.

The present invention should not be limited to the preferred embodiment described below, but may be modified in various forms without departing the spirit of the invention. Therefore, the various embodiments of the invention will be in detail explained with reference to the attached drawings. However, it should be understood that the invention is not limited to the preferred embodiment of the present invention, and many changes, variations and modifications of the constructional details illustrated and described may be resorted to without departing from the spirit of the invention.

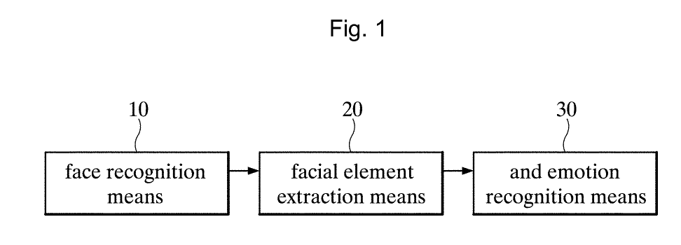

FIG. 1 is a block diagram showing a configuration of an emotion recognition apparatus using facial expressions according to the present invention. As shown in FIG. 1, an emotion recognition apparatus using facial expressions according to the present invention largely includes face recognition means 10, facial element extraction means 20, and emotion recognition means 30.

The face recognition means 10 serves to recognize the face of a given object from a plurality of objects contained in an acquired video and to collect the information corresponding to the face of the given object.

Next, the facial element extraction means 20 serves to extract given elements contained in the face so as to recognize the variations in the expressions of the face recognized through the face recognition means 10. A detailed explanation on the facial element extraction means 20 will be given later with reference to the attached drawings.

Further, the emotion recognition means 30 serves to finally determine the emotion of the face using the extracted information through the facial element extraction means 20. A detailed explanation on the emotion recognition means 30 will be also given later with reference to the attached drawings.

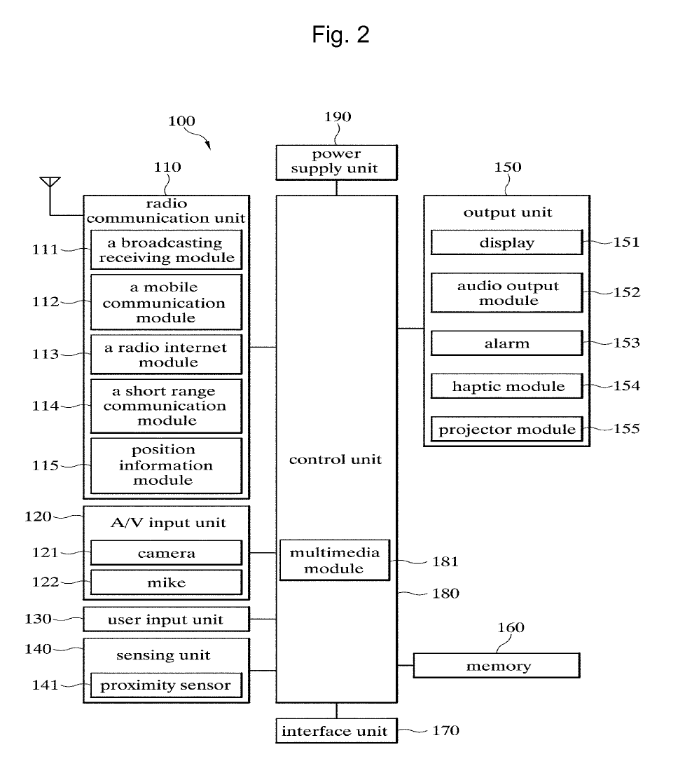

FIG. 2 is a block diagram showing the face recognition means, the facial element extraction means, and the emotion recognition means in the emotion recognition apparatus using facial expressions according to the present invention.

Each of the face recognition means 10, the facial element extraction means 20, and the emotion recognition means 30 includes at least one of the components as shown in FIG. 2.

An emotion recognition apparatus 100 according to the present invention includes a radio communication unit 110, an audio/video input unit 120, a user input unit 130, a sensing unit 140, an output unit 150, a memory 160, an interface unit 170, a control unit 180, and a power supply unit 190.

However, the components in FIG. 2 are not necessarily provided, and therefore, the emotion recognition apparatus 100 according to the present invention may include the number of components larger or smaller than that in FIG. 2.

Hereinafter, the above-mentioned components of the emotion recognition apparatus 100 according to the present invention includes will be described one by one.

The radio communication unit 110 may include one or more modules capable of performing radio communication between the emotion recognition apparatus 100 and a radio communication system or between the emotion recognition apparatus 100 and network on which the emotion recognition apparatus 100 is positioned. For example, the radio communication unit 110 includes a broadcasting receiving module 111, a mobile communication module 112, a radio internet module 113, a short range communication module 114, and a position information module 115.

The broadcasting receiving module 111 serves to receive broadcasting signals and/or information related to broadcasting from an outside broadcasting management server through broadcasting channels.

The broadcasting channels may include satellite channels and terrestrial channels. The broadcasting management server means a server that produces and sends broadcasting signals and/or information related to broadcasting, or means a server that receives the previously produced broadcasting signals and/or information related to broadcasting and sends that to a terminal. The broadcasting signals may include TV broadcasting signals, radio broadcasting signals, data broadcasting signals, and broadcasting signals to which the data broadcasting signals are combined with the TV broadcasting signals or the radio broadcasting signals.

The information related to broadcasting means the information on broadcasting channels, broadcasting programs, or broadcasting service provider. The information related to broadcasting may be provided through mobile communication networks. In this case, the information related to broadcasting is received by means of the mobile communication module 112.

The information related to broadcasting exists in various forms. For example, the information related to broadcasting exists in the form of an EPG (Electronic Program Guide) of DMB (Digital Multimedia Broadcasting) or in the form of an ESG (Electronic Service Guide) of DVB-H (Digital Video Broadcast-Handheld).

The broadcasting receiving module 111 receives digital broadcasting signals by using digital broadcasting systems such as DMB-T (Digital Multimedia Broadcasting-Terrestrial), DMB-S (Digital Multimedia Broadcasting-Satellite), DVB-H (Digital Video Broadcast-Handheld), and ISDB-T (Integrated Services Digital Broadcast-Terrestrial) In addition to the above-mentioned digital broadcasting systems, of course, the broadcasting receiving module 111 may be adapted to other broadcasting systems.

The broadcasting signals and/or information related to broadcasting received through the broadcasting receiving module 111 are stored in the memory 160.

The mobile communication module 112 transmits and receives radio signals to and from at least one of base station, outside terminal and, server on mobile communication networks. The radio signals include a voice call signal, a video conference call signal, or data in various forms according to the transmission and reception of text/multimedia messages.

The radio internet module 113 serves to perform radio internet connection, which is mounted inside or outside the emotion recognition apparatus 100. WLAN (WIRELESS LAN) (Wi-Fi), Wibro (Wireless broadband), Wimax (World Interoperability for Microwave Access), HSDPA (High Speed Downlink Packet Access) are used as radio internet technologies.

The short range communication module 114 serves to perform short range communication, and Bluetooth, RFID (Radio Frequency Identification), IrDA (Infrared Data Association), UWB (Ultra Wideband), and ZigBee are used as short range communication technologies.

The position information module 115 serves to obtain the position of the emotion recognition apparatus 100, and for example, a GPS (Global Position. System) may be used.

Referring to FIG. 2, the A/V (Audio/Video) input unit 120 serves to input an audio signal or a video signal, which includes a camera 121 and a mike 122. The camera 121 serves to process video frames of still video or moving video acquired by an image sensor in a video conference mode or a photographing mode. The processed video frames are displayed on a display 151.

The video frames processed in the camera 121 are stored in the memory 160 or transmitted to the outside through the radio communication unit 110. Two or more cameras 121 may be provided in accordance with the environments used thereof.

The mike 122 receives outside audio signals by means of a microphone in a communication mode, a recording mode, a voice recognition mode and so on and processes the received audio signals as electrical voice data. The processed voice data is converted and outputted into a form capable of being transmitted to the mobile communication base station through the mobile communication module 112 in case of the communication mode. The mike 122 may have a variety of noise-removing algorithms adapted to remove noise occurring in the process of inputting the outside audio signals.

The user input unit 130 serves to allow a user to generate input data for controlling the operations of the emotion recognition apparatus 100. The user input unit 130 may include a key pad, a dome switch, a touchpad (constant pressure type/capacitive), a jog wheel, a jog switch and the like.

The sensing unit 140 serves to sense the current states of the emotion recognition apparatus 100 such as the opening/closing state, position, existence/non-existence of user contact therewith, direction, acceleration/deceleration thereof so as to generate the sensing signals for controlling the operations of the emotion recognition apparatus 100. For example, if the emotion recognition apparatus 100 is provided in a form of a slide phone, the sensing unit 140 senses the opening/closing state of the slide phone. Further, the sensing unit 140 senses whether the power from the power supply unit 190 is supplied or not and the interface unit 170 is connected to outside equipment or not. On the other hand, the sensing unit 140 includes a proximity sensor 141.

The output unit 150 serves to generate the outputs related to the sense of sight, the sense of hearing or the sense of touch, which includes the display 151, an audio output module 152, an alarm 153, a haptic module 154, and a projector module 155.

The display 151 serves to display (output) the information processed in the emotion recognition apparatus 100. For example, in case where the emotion recognition apparatus 100 is in the communication mode, the display 151 displays UI (User Interface) or GUI (Graphic User Interface) related to the communication. On the other hand, in case where the emotion recognition apparatus 100 is in the video communication mode or the photographing mode, the display 151 displays the photographed or/and received video, UI (User Interface) or GUI (Graphic User Interface).

The display 151 includes at least one of LCD (Liquid Crystal Display), TFT LCD (Thin Film Transistor-Liquid Crystal Display), OLED (Organic Light-Emitting Diode), flexible display, and three-directional display.

Some of the above-mentioned displays may be transparent or light-transmissive, so that the outside can be seen therethrough. They are called transparent displays, and the representative example of the transparent displays is TOLED (Transparent OLED). The rear side of the display 151 may be light-transmissive. Accordingly, the items positioned at the rear side of the terminal body can be seen to the user through the area occupied by the display 151 of the terminal body.

Two or more displays 151 may be provided in accordance with the embodiments of the emotion recognition apparatus 100. For example, the emotion recognition apparatus 100 may have a plurality of displays spaced apart from each other or arranged integrally to each other on a single face thereof, or arranged respectively on different faces from each other.

If the display 151 and a sensor sensing a touch operation (hereinafter, referred to as ‘touch sensor’) have an interlayered structure (hereinafter, referred to as ‘touch screen’), the display 151 can be used as an input, device as well as an output device. For example, the touch sensor includes a touch film, a touch sheet, a touch pad and the like.

The touch sensor converts the pressure applied to a given portion of the display 151 and the variation of the electrostatic capacity generated on a given portion of the display 151 into an electrical input signal. The touch sensor detects the touched position, the touched area, and the pressure applied at the time of the touch.

If the touch input occurs through the touch sensor, the signal (s) corresponding to the touch input is (are) sent to a touch controller. The signal(s) is (are) processed in the touch controller, and the corresponding data is sent to the control unit 180, so that the control unit 180 recognizes what the touched area of the display 151 is.

The proximity sensor 141 is mounted in the internal area of the emotion recognition apparatus 100 surrounded with the touch screen or in the vicinity of the touch screen. The proximity sensor 141 detects whether an item approaches a given detection face or an item exists around or not by using a force generated from an electromagnetic field or infrared rays, without having any mechanical contact. The proximity sensor 141 has a longer life term and a higher degree of utilization than a contact sensor.

Examples of the proximity sensor 141 are a transmissive photoelectric sensor, a direct reflective photoelectric sensor, a mirror reflective photoelectric sensor, a high frequency oscillating proximity sensor, a capacitive type proximity sensor, a magnetic proximity sensor, an infrared proximity sensor and the like. In case where the touch screen is capacitive, it detects the proximity of a pointer in accordance with the variations of the electric field caused by the proximity of the pointer. In this case, the touch screen (touch sensor) becomes the proximity sensor.

For the convenience of the description, hereinafter, the situation where the pointer is located over the touch screen, without any contact therewith will be called “proximity touch”, and the situation where the pointer is really contacted with the touch screen will be called “contact touch”. The proximity touch on the touch screen through the pointer means that the pointer is located at a position vertically corresponding to the touch screen when the pointer is proximately touched thereon.

The proximity sensor serves to sense proximity touch and proximity touch patterns (for example, proximity touch distance, proximity touch direction, proximity touch speed, proximity touch time, proximity touch position, proximity touch moving state and so on). The information corresponding to the sensed proximity touch and proximity touch pattern is outputted on the touch screen.

The audio output module 152 serves to output the audio data received from the radio communication unit 110 or stored n the memory 160 in case of call signal reception, communication mode or recording mode, voice recognition mode, and broadcasting reception mode. The audio output module 152 also outputs the audio signals related to the functions (for example, a call signal reception sound, a message reception sound and the like) performed in the emotion recognition apparatus 100. The audio output module 152 may include a receiver, a speaker, a buzzer and so on.

The alarm 153 serves to output signals for notifying the generation of events of the emotion recognition apparatus 100. The examples of the events generated in the emotion recognition apparatus 100 are call signal reception, message reception, key signal input, touch input and the like. In addition to video signals or audio signals, the alarm 153 may output the signals for notifying the generation of events of the emotion recognition apparatus 100 through other ways, for example, vibration. The video signals or the audio signals are outputted through the display 151 or the audio output module 152, and therefore, the display 151 and the audio output module 152 become a part of the alarm 153.

The haptic module 154 serves to generate various haptic effects felt by the user. A representative example of the haptic effects generated through the haptic module 154 is vibration. The strength and pattern of the vibration generated from the haptic module 154 can be controlled. For example, different vibrations are combinedly or sequentially outputted.

In addition to the vibration, the haptic module 154 generates various haptic effects such as pin array moving vertically with respect to contact skin surface, air injection force or air sucking force through injection hole or suction hole, touch on skin surface, contact of electrode, electrostatic force, and effects of thermal sensation representation using endothermic or exothermic elements.

The haptic module 154 provides the haptic effects through direct contacts as well as through muscle senses of the user's fingers or arms. Two or more haptic modules 154 may be provided in accordance with the configuration of the emotion recognition apparatus 100.

The projector module 155 serves to perform image projection by using the emotion recognition apparatus 100 and to display the same image as displayed on the display 151 or the image partially different from the image displayed on the display 151 on an outside screen or wall under a control signal of the control unit 180.

In more detail, projector module 155 may include light source (not shown) for generating light (for example, laser light) through which image is outputted to the outside, image producing means (not shown) for producing the image to be outputted to the outside by using the light generated by the light source, and a lens (not shown) for enlarging and outputting the image to the outside in a given focal distance. Further, the projector module 155 may include a device (not shown) for mechanically moving the lens or the module itself to adjust the image projection direction.

The projector module 155 may be classified into a CRT (Cathode Ray Tube) module, an LCD (Liquid Crystal Display) module, and a DLP (Digital Light Processing) module in accordance with the device kinds of the display means. Especially, the DLP module is configured to enlarge and project the image produced through the reflection of the light generated from the light source on a DMD (Digital Micromirror Device) chip, which achieves the miniaturization of the projector module 151.

Desirably, the projector module 155 may be provided in a lengthwise direction on the side, front or back of the emotion recognition apparatus 100. Of course, the projector module 155 may be provided at any position of the emotion recognition apparatus 100 if necessary.

The memory 160 serves to store the programs for the process and control of the control unit 180 thereinto and to temporarily store the data inputted/outputted (for example, telephone numbers, messages, audio, still video, moving video and the like). The memory 160 also stores the frequencies of use of the data (for example, the frequencies of use of each telephone number, each message, and each multimedia). Further, the memory 160 stores the data on the vibrations and audios having various patterns outputted at the time of the touch input on the touch screen.

The memory 160 includes at least one of various storage media types such as flash memory type, hard disk type, multimedia card micro type, card type memory (for example, SD or XD memory), RAM (Random Access Memory), SRAM (Static Random Access Memory), ROM (Read-Only Memory), EEPROM (Electrically Erasable Programmable Read-Only Memory), PROM (Programmable Read-Only Memory), magnetic memory, magnetic disk, optical disk and the like. The emotion recognition apparatus 100 may be operated in conjunction with web storage performing the storage function of the memory 160.

The interface unit 170 serves as a passage for all of external devices connected to the emotion recognition apparatus 100. The interface unit 170 serves to receive data or power from the external devices so as to transmit the received data or power to each unit of the emotion recognition apparatus 100 and also to transmit the data in the emotion recognition apparatus 100 to the external devices. For example, the interface unit 170 includes a wire/wireless headset port, an external charger port, a wire/wireless data port, a memory card, port, a port for connecting a device having an identity module, an audio I/O (Input/Output) port, a video I/O (Input/Output) port, an earphone port and the like.

The identity module is a chip where all kinds of information for identifying the authorization of the emotion recognition apparatus 100 is stored, which includes a UIM (User Identity Module), SIM (Subscriber Identity Module), USIM (Universal Subscriber Identity Module) and the like. The device (hereinafter, referred simply as ‘identity device’) having the identity module can be made in a form of a smart card. Accordingly, the identity device is connected with the terminal 100 through the port.

When the emotion recognition apparatus 100 is connected with an external cradle, the interface unit 170 serves as the passage through which the power of the external cradle is supplied to the emotion recognition apparatus 100 or as the passage through which all kinds of command signals received from the external cradle are transmitted to the emotion recognition apparatus 100. The various command signals and power received from the external cradle can be operated as signals with which it is checked that the emotion recognition apparatus 100 is accurately mounted on the external cradle.

The control unit 180 serves to control the whole operations of the emotion recognition apparatus 100. For example, the control unit 180 controls and processes voice communication, data communication, video communication and so on. The control unit 180 includes a multimedia module 181 for playing multimedia. The multimedia module 181 may be provided in the control unit 180 or provided separately therefrom.

The control unit 180 conducts pattern recognition processing where writing input or drawing input carried out on the touch screen is recognized as characters or images.

The power supply unit 190 serves to receive external power or internal power so as to supply the received power as the power needed for the operation of each unit, under the control of the controller 180.

Various embodiments of the present invention as described herein are applied to recording media readable through a computer or devices similar to the computer by using software, hardware or something made by combining the software and hardware.

The hardware embodiment is carried out by using at least one of ASICs (Application Specific Integrated Circuits), DSPs (Digital Signal Processors), DSPDs (Digital Signal Processing Devices), PLDs (Programmable Logic Devices), FPGAs (Field Programmable Gate Arrays), processors, controllers, micro-controllers, microprocessors, and electric units for performing other functions. In some cases, the embodiments of the present invention can be carried out by means of the control unit 180 itself.

According to the software embodiment, the embodiments of the present invention having the procedure and functions as described herein are carried out by means of separate software modules. Each of the software modules performs one or more functions and operations as mentioned herein. The software code can be provided with software applications written with appropriate program languages. The software code is stored in the memory 160 and carried out by means of the control unit 180.

The emotion recognition apparatus 100 using the facial expressions according to the present invention senses the variations of the facial expressions of the object and classifies the sensed results into six kinds of emotions (for example, joy, surprise, sadness, anger, fear and disgust).

However, the classified six kinds of emotions are just examples applied to the preferred embodiments of the present invention, and therefore, six or more kinds of emotions may be classified with respect to other references.

The face recognition means 10 according to the present invention receives the information on the object responding to a suggested stimulus and recognizes the face of the object. At this time, the object becomes an object whose emotion is recognized. The object may be a human being or an animal whose emotion should be recognized.

The information of the object is the information of the object to be measured, which is moving video data or still video data acquired through the photographing of the object.

If the moving video or still video of the object is photographed through a camera (not shown), the produced digital data may become the information of the object.

Further, the facial element extraction means 20 according to the present invention extracts the facial elements of the object by using the face of the object recognized through the face recognition means 10.

In this case, the face recognition means 10, the facial element extraction means 20, and the emotion recognition means 30 whose functions are just defined for the brevity of the description, and therefore, their functions may be carried out by means of a single calculating computer. If necessary, the functions are separately carried out by means of the respective calculating computers.

Hereinafter, an emotion recognition method using the facial expressions of the object through the emotion recognition apparatus 100 will be in detail explained.

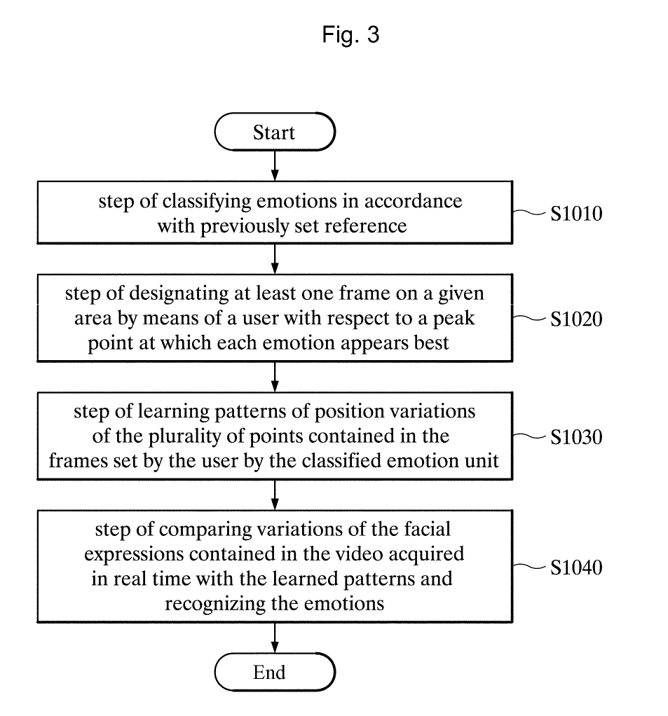

FIG. 3 is a flow chart showing an emotion recognition method using facial expressions according to the present invention.

For the convenience of the description, it is assumed that the object to which the embodiments of the present invention are applied is a human being, but the present invention is not limited thereto.

First, emotions are classified into a plurality of categories according to previously set references.

As mentioned above, the classified emotion categories become joy, surprise, sadness, anger, fear and disgust. However, the present invention is not limited to the classified six kinds of emotions, and therefore, six or more kinds of emotions may be classified with respect to other references.

Next, at least one frame on a given area is designated by means of a user with respect to a peak point at which each emotion appears best (at step S1020).

This is to simplify the information to be analyzed to recognize the emotions of the user, and accordingly, the analyzed values become more accurate.

That is, given videos can be acquired by the units of joy, surprise, sadness, anger, fear and disgust.

For example, the video of the user excited when he wins in a lottery, the video of the user feared when he watches the horror movie, and the video of the user sad when his well-known person is dead.

At this time, the frames in which the emotions of the user are at peak points are designated by the user from the acquired respective videos.

Further, a plurality of frames may be designated with respect to the video frames corresponding to the peak points designated by the user.

For example, 56th video frame from the 100 video frames corresponding to the emotion of joy can be designated as the frame corresponding to the peak point of the emotion of joy.

Accordingly, 53rd to 55th video frames and 57th to 59th video frames corresponding to before and after three video frames with respect to the 56th video frame are automatically designated as the video frames for analysis.

Next, the patterns of the position variations of the plurality of points contained in the frames set by the user by the classified emotion unit are learned by means of the emotion recognition apparatus 100 (at step S1030).

In more detail, a plurality of points in the face area contained in each frame designated by the user is automatically designated by the control of the control unit 180.

That is, the moving video data or still video data is received as the information of the object, and the feature points of the received data are extracted by using an ASM (Active Shape Model) algorithm.

Further, the patterns of the position variations of the plurality of points contained in each frame designated by the user by the classified emotions are learned by means of the emotion recognition apparatus 100.

For example, the pattern of the position variations of the plurality of points corresponding to the emotion of joy is learned, and the pattern of the position variations of the plurality of points corresponding to the emotion of surprise is learned. The pattern of the position variations of the plurality of points corresponding to the emotion of anger is learned, the pattern of the position variations of the plurality of points corresponding to the emotion of fear is learned, and the pattern of the position variations of the plurality of points corresponding to the emotion of disgust is learned.

For the convenience of the description, hereinafter, the pattern of the position variations of the plurality of points corresponding to the emotion of joy is called a first position variation learning pattern, the pattern of the position variations of the plurality of points corresponding to the emotion of surprise a second position variation learning pattern, the pattern of the position variations of the plurality of points corresponding to the emotion of sadness a third position variation learning pattern, the pattern of the position variations of the plurality of points corresponding to the emotion of anger a fourth position variation learning pattern, the pattern of the position variations of the plurality of points corresponding to the emotion of fear a fifth position variation learning pattern, and the pattern of the position variations of the plurality of points corresponding to the emotion of disgust a sixth position variation learning pattern.

After that, the variations of the facial expressions contained in the video acquired in real time through the camera are compared with the learned patterns, thereby recognizing the facial expressions (at step S1040).

At this time, examples of the variations of the facial expressions of the object are the variation of the eye size, the variation of the gap between eye and eyebrow, the variation of the shape of the middle of the forehead, the variation of the mouth size, and the variation of the shape of the mouth. In this case, the classification and recognition into the six kinds of emotions may be performed by means of Bayesian classifier.

Representatively, an HMM (Hidden Markov Model) algorithm is applied to the step S1040.

For example, if the patterns of the variations of the facial expressions contained in the video acquired in real time are the same as the first position variation learning pattern, the control unit 180 confirms that the emotion of the object contained in the video is joy.

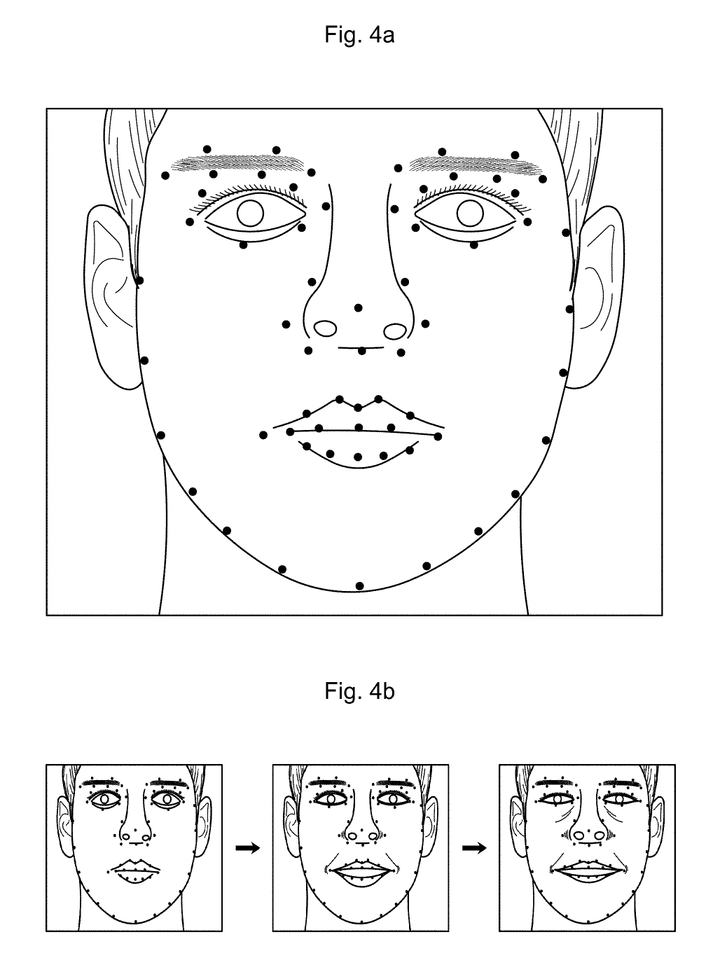

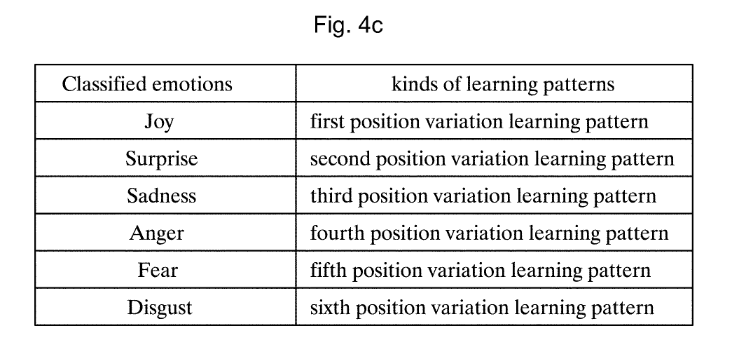

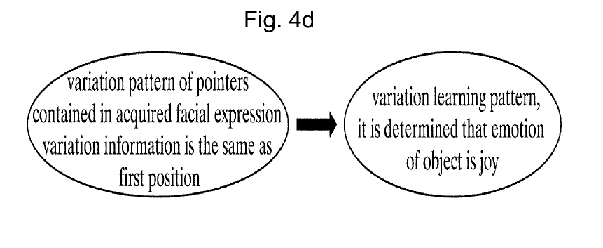

FIGS. 4a to 4d are exemplary views showing the emotion recognition method using facial expressions according to the Present invention.

For the convenience of the description, first, it is assumed that the emotions have been classified into a plurality of categories (at the step S1010) according to previously set references and at least one frame of a given area has been designated by means of the user with respect to a peak point at which each emotion appears best (at the step S1020), before FIGS. 4a to 4d.

That is, it is assumed that a plurality of frames for analysis is designated with respect to the video frames corresponding to the peak points designated by the user.

Referring first to FIG. 4a, the step S1030 is carried out wherein a plurality of points in the face area contained in each frame designated by the user is automatically designated by the control of the control unit 180.

As mentioned above, a method for designating the video is carried out manually, and the video frame is limited to a range to peak points of the emotion expressions from neutral expressions.

Also, the peak points of the emotion expressions are selected by the intuition of a researcher, and the lengths of video clips are different since the expression durations are different.

At this time, the coordinates x and y of the principal points of each frame of the moving video can be extracted by means of the control unit 180.

For example, as shown in FIG. 4a, the coordinates x and y of each of 68 principal points of the face of the object are extracted by using the ASM.

FIG. 4a shows the present invention applied to the video recorded at 15 frames per second.

Further, the patterns of the position variations of the plurality of points contained in the frames set by the user by the classified emotion unit are learned to the emotion recognition apparatus 100 by the control of the control unit 180.

Referring to FIG. 4b, 10 feature vector values are calculated by using the coordinates x and y and compared to each other, thereby recognizing the variation patterns.

In this case, the 10 feature vector values are given in the following Table 1 by using the coordinates x and y of the object positioned at the far left side.

TABLE 1

| | |
|---|---|
| Var 01 | Right eyebrow curvature = |
| | (21, 24)/[distance from 23 to L(21, 24)] |
| Var 02 | Left eyebrow curvature = |
| | (15, 18)/[distance from 17 to L(15, 18)] |
| Var 03 | Mouth curvature = (48, 54)/(51, 57) |
| Var 04 | Ratio of eye height to mouth height = |
| | (28, 30)/(51, 57) |
| Var 05 | Ratio of nose width to mouth width = |
| | (nose width)/(mouth width) = |
| | (39, 43)/(48, 54) |
| Var 06 | Left eyebrow curvature/mouth curvature = |
| | [(15, 18)/[distance from 17 to L(15, 18)]]/ |
| | [(48, 54)/(51, 57)] |
| Var 07 | (right eyebrow curvature)/(ratio of nose width |
| | to mouth width) = |
| | [(21, 24)/(distance from 23 to |
| | L(21, 24))]/[(39, 43]/(48, 54)] |
| Var 08 | (left eyebrow curvature)/(ratio of nose width |
| | to mouth width) = |
| | [(15, 18)/(distance from 17 to |
| | L(15, 18))]/[(39, 43]/(48, 54)] |

In the Table 1, (a, b) indicates the distance from point ‘a’ to point ‘b’, and L(a, b) indicates the distance of the linear line from point ‘a’ to point ‘b’.

So as to reduce the machine learning time and to avoid the problem of underflow, on the other hand, each video clip is divided into 9 sections, and 10 frames inclusive of start and end frames are extracted from each of the 9 sections.

Further, the HMMs for the respective emotions are made to perform the machine learning thereof.

For example, if six kinds of emotions are adopted, six HMM algorithms are applied.

As shown in FIG. 4c, accordingly, the first position variation learning pattern is learned as the pattern of the position variations of the plurality of points corresponding to the emotion of joy, the second position variation learning pattern is learned as the pattern of the position variations of the plurality of points corresponding to the emotion of surprise, the third position variation learning pattern is learned as the pattern of the position variations of the plurality of points corresponding to the emotion of sadness, the fourth position variation learning pattern is learned as the pattern of the position variations of the plurality of points corresponding to the emotion of anger, the fifth position variation learning pattern is learned the pattern of the position variations of the plurality of points corresponding to the emotion of fear, and the sixth position variation learning pattern is learned the pattern of the position variations of the plurality of points corresponding to the emotion of disgust.

Further, as shown in FIG. 4d, if the variation pattern of the pointers contained in the acquired facial expression variation information is the same as the first position variation learning pattern, it is determined by the control unit 180 that the emotion of the object contained in the video is joy.

On the other hand, according to another embodiment of the present invention, if the variation pattern of the pointers contained in the acquired video does not correspond to the previously stored pattern, the emotion corresponding to most similar to a given pattern in the previously stored patterns is recognized as the emotion of the object contained in the video.

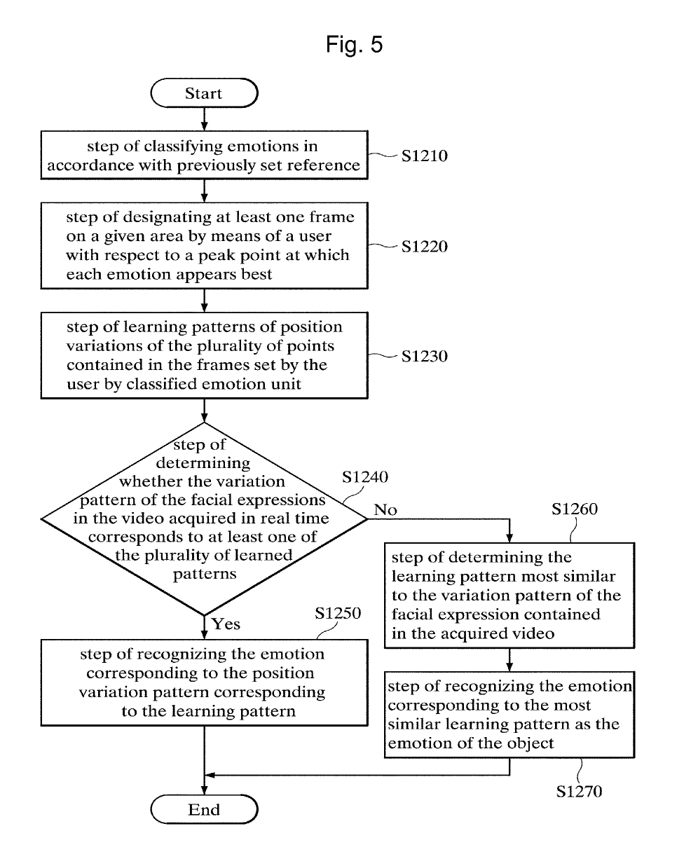

FIG. 5 is a flow chart showing another emotion recognition method using facial expressions according to the present invention.

Steps S1210 to S1230 in FIG. 5 correspond to the steps S1010 to S1030 in FIG. 3, and for the brevity of description, they will be not explained hereinafter.

After the position variation pattern of the plurality of points by the emotion unit is learned at the step S1230, it is determined whether the variation pattern of the facial expressions in the video acquired in real time corresponds to at least one of the plurality of learned patterns by means of the control unit 180, at step S1240.

If the variation pattern acquired corresponds to any of the previously stored plurality of learning patterns, the emotion corresponding to the position variation pattern corresponding to the learning pattern is recognized by means of the control unit 180 at step S1250.

If the variation pattern acquired does not correspond to any of the previously stored plurality of learning patterns, the learning pattern most similar to the variation pattern of the facial expression contained in the acquired video is determined at step S1260.

After that, the emotion corresponding to the most similar learning pattern is recognized as the emotion of the object at step S1270.

For example, the probabilities of the test sequence not used in the learning are calculated in the six emotion models. That is, the probability of the occurrence of the test sequence is calculated in each emotion model, and if the test sequence occurs in the emotion model from which the highest probability is calculated, the test sequence is determined as the emotion corresponding to the emotion model.

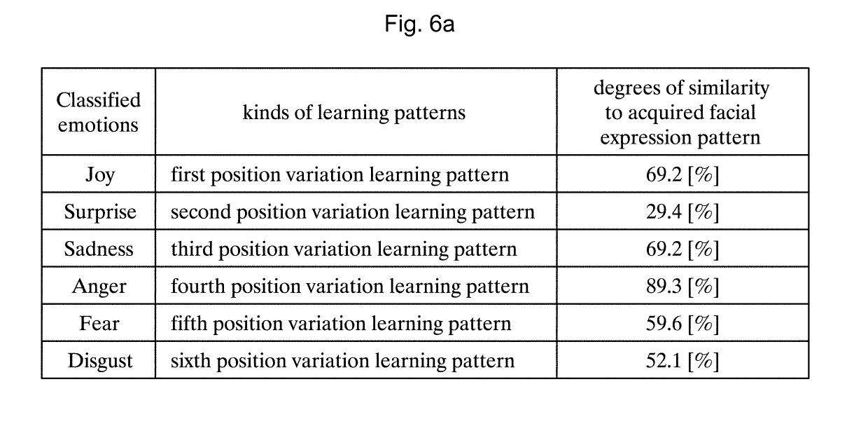

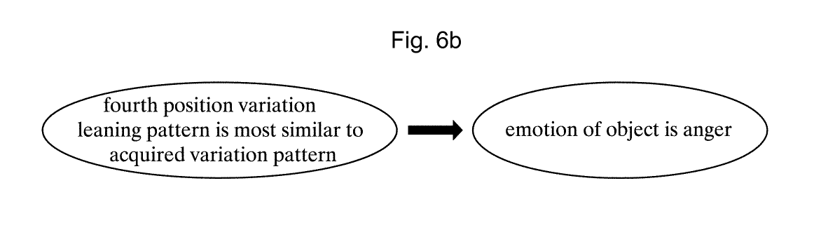

FIGS. 6a and 6b are exemplary views showing still another emotion recognition method using facial expressions according to the present invention.

Referring to FIG. 6a, if the variation pattern acquired does not correspond to any of the previously stored plurality of learning patterns, the contents related to the step S1260 wherein it is determined what the learning pattern most similar to the variation pattern of the facial expression contained in the acquired video is are summarized by means of the control unit. 180.

That is, the degrees of similarity of the first to sixth position variation learning patterns to the variation patterns of the points acquired are indicated.

Referring to FIG. 6a, it is appreciated that the fourth position variation leaning pattern is most similar to the acquired variation pattern.

Accordingly, as shown in FIG. 6b, it is determined by the control unit 180 that the emotion of the object is anger.

Further, the above-mentioned methods are carried out with the codes readable by the processor on a media where programs are recorded. Examples of the media readable by the processor are ROM, RAM, CD-ROM, magnetic tape, floppy disk, optical data storing device, and a carrier wave (for example, transmission via internet).

As described above, the emotion recognition apparatus using facial expressions according to at least one of the preferred embodiments of the present invention measures the variations of the facial expressions of the object to objectively recognize the 6 kinds of emotions from the measured facial expressions of the object.

Further, the emotion recognition apparatus using facial expressions according to at least one of the preferred embodiments of the present invention recognizes the emotional state of the object through the measurement of the variations of the facial expressions of the object, so that if the emotion recognition apparatus is implanted to chips for the disabled, many advantages can be provided.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. An emotion recognition apparatus using facial expressions comprising:
a camera adapted to acquire a first video of an object corresponding to each of a plurality of emotions classified by a previously set reference;
a user input unit adapted to receive a plurality of first frames in the first video designated by a user;
a control unit adapted to recognize the face of the object contained in the plurality of first frames, extracting the facial elements of the object by using the recognized face, and extracting the variation patterns of the plurality of emotions by using the facial elements; and
a memory adapted to store the extracted variation patterns of the plurality of emotions, wherein if a second video of the object is acquired through the camera, a first variation pattern of the facial elements of the object contained in the second video is extracted, and the emotion corresponding to the variation pattern that is the same as the first variation pattern from the plurality of variations patterns stored in the memory is determined as the emotion of the object by means of the control unit.

2. An emotion recognition apparatus using facial expressions comprising:
a camera adapted to acquire a first video of an object corresponding to each of a plurality of emotions classified by a previously set reference;
a user input unit adapted to receive a plurality of first frames in the first video designated by a user;
a control unit adapted to recognize the face of the object contained in the plurality of first frames, extracting the facial elements of the object by using the recognized face, and extracting the variation patterns of the plurality of emotions by using the facial elements; and
a memory adapted to store the extracted variation patterns of the plurality of emotions, wherein if a second video of the object is acquired through the camera, a first variation pattern of the facial elements of the object contained in the second video is extracted, and the emotion corresponding to the variation pattern that is most similar to the first variation pattern from the plurality of variations patterns stored in the memory is determined as the emotion of the object by means of the control unit.

3. The emotion recognition apparatus using facial expressions according to claim 1, wherein the plurality of emotions classified by the previously set reference is joy, surprise, sadness, anger, fear and disgust.

4. The emotion recognition apparatus using facial expressions according to claim 1, wherein the first video and the second video are moving video data or still video data acquired by photographing the face of the object.

5. The emotion recognition apparatus using facial expressions according to claim 1, wherein the facial elements of the object comprise at least one of eyes, eyebrows, the middle of the forehead, and mouth.

6. The emotion recognition apparatus using facial expressions according to claim 1, wherein the control unit extracts the facial elements of the object by using an ASM (Active Shape Model) algorithm.

7. The emotion recognition apparatus using facial expressions according to claim 6, wherein the control unit extracts the features of a plurality of coordinates x and y by using the face of the object contained in the first video and the second video and thus extracts the facial elements of the object by using the extracted features of the plurality of coordinates x and y.

8. The emotion recognition apparatus using facial expressions according to claim 6, wherein the first video is divided into 9 sections through the user input unit, and the number of the plurality of first frames is 10 inclusive of start and end frames of each section.

9. The emotion recognition apparatus using facial expressions according to claim 1, wherein the control unit extracts the variation pattern of each of the plurality of emotions by using an HMM (Hidden Markov Model) algorithm.

10. An emotion recognition method using facial expressions comprising the steps of:
acquiring a first video of an object corresponding to each of a plurality of emotions classified by a previously set reference;
receiving a plurality of first frames designated in the first video;
recognizing the face of the object contained in the plurality of first frames;
extracting the facial elements of the object by using the recognized face;
extracting the variation patterns of the plurality of emotions by using the facial elements;
storing the extracted variation patterns of the plurality of emotions;
acquiring a second video of the object;
extracting a first variation pattern of the facial elements of the object contained in the second video; and
determining the emotion corresponding to the variation pattern that is the same as the first variation pattern from the plurality of stored variations patterns as the emotion of the object.

11. An emotion recognition method using facial expressions comprising the steps of:
acquiring a first video of an object corresponding to each of a plurality of emotions classified by a previously set reference;
receiving a plurality of first frames designated in the first video;
recognizing the face of the object contained in the plurality of first frames;
extracting the facial elements of the object by using the recognized face;
extracting the variation patterns of the plurality of emotions by using the facial elements;
storing the extracted variation patterns of the plurality of emotions;
acquiring a second video of the object;
extracting a first variation pattern of the facial elements of the object contained in the second video; and
determining the emotion corresponding to the variation pattern that is most similar to the first variation pattern from the plurality of stored variations patterns as the emotion of the object.

12. The emotion recognition method using facial expressions according to claim 10, wherein the plurality of emotions classified by the previously set reference is joy, surprise, sadness, anger, fear and disgust.

13. The emotion recognition method using facial expressions according to claim 10, wherein the first video and the second video are moving video data or still video data acquired by photographing the face of the object.

14. The emotion recognition method using facial expressions according to claim 10, wherein the facial elements of the object comprise at least one of eyes, eyebrows, the middle of the forehead, and mouth.

15. The emotion recognition method using facial expressions according to claim 10, wherein the control unit extracts the facial elements of the object by using an ASM (Active Shape Model) algorithm.

16. The emotion recognition method using facial expressions according to claim 15, wherein the step of extracting the facial elements of the object comprises the steps of:
extracting the features of a plurality of coordinates x and y by using the face of the object contained in the first video and the second video; and
extracting the facial elements of the object by using the extracted features of the plurality of coordinates x and y.

17. The emotion recognition method using facial expressions according to claim 15, wherein the step of receiving the plurality of first frames designated in the first video comprises the steps of:
dividing the first video into 9 sections; and
designating 10 frames inclusive of start and end frames of each of the 9 sections as the plurality of first frames.

18. The emotion recognition method using facial expressions according to claim 10, wherein the control unit extracts the variation pattern of each of the plurality of emotions by using an HMM (Hidden Markov Model) algorithm.

19. An emotion recognition method using facial expressions in a recording medium where programs of commands executed by a digital processing device are typologically set in such a manner as to be readable by means of the digital processing device, the method comprising the steps of:
acquiring a first video of an object corresponding to each of a plurality of emotions classified by a previously set reference;
receiving a plurality of first frames designated in the first video;
recognizing the face of the object contained in the plurality of first frames;
extracting the facial elements of the object by using the recognized face;
extracting the variation patterns of the plurality of emotions by using the facial elements;
storing the extracted variation patterns of the plurality of emotions;
acquiring a second video of the object;
extracting a first variation pattern of the facial elements of the object contained in the second video; and
determining the emotion corresponding to the variation pattern that is the same as the first variation pattern from the plurality of stored variations patterns as the emotion of the object.

20. An emotion recognition method using facial expressions in a recording medium where programs of commands executed by a digital processing device are typologically set in such a manner as to be readable by means of the digital processing device, the method comprising the steps of:
acquiring a first video of an object corresponding to each of a plurality of emotions classified by a previously set reference;
receiving a plurality of first frames designated in the first video;
recognizing the face of the object contained in the plurality of first frames;
extracting the facial elements of the object by using the recognized face;
extracting the variation patterns of the plurality of emotions by using the facial elements;
storing the extracted variation patterns of the plurality of emotions;
acquiring a second video of the object;
extracting a first variation pattern of the facial elements of the object contained in the second video; and
determining the emotion corresponding to the variation pattern that is most similar to the first variation pattern from the plurality of stored variations patterns as the emotion of the object.

21. The emotion recognition method using facial expressions according to claim 19, wherein the plurality of emotions classified by the previously set reference is joy, surprise, sadness, anger, fear and disgust.

22. The emotion recognition method using facial expressions according to claim 19, wherein the first video and the second video are moving video data or still video data acquired by photographing the face of the object.

23. The emotion recognition method using facial expressions according to claim 19, wherein the facial elements of the object comprise at least one of eyes, eyebrows, the middle of the forehead, and mouth.

24. The emotion recognition method using facial expressions according to claim 19, wherein the control unit extracts the facial elements of the object by using an ASM (Active Shape Model) algorithm.

25. The emotion recognition method using facial expressions according to claim 24, wherein the step of extracting the facial elements of the object comprises the steps of:
extracting the features of a plurality of coordinates x and y by using the face of the object contained in the first video and the second video; and
extracting the facial elements of the object by using the extracted features of the plurality of coordinates x and y.

26. The emotion recognition method using facial expressions according to claim 24, wherein the step of receiving the plurality of first frames designated in the first video comprises the steps of:
dividing the first video into 9 sections; and
designating 10 frames inclusive of start and end frames of each of the 9 sections as the plurality of first frames.

27. The emotion recognition method using facial expressions according to claim 19, wherein the control unit extracts the variation pattern of each of the plurality of emotions by using an HMM (Hidden Markov Model) algorithm.
